(19) United States
(12) Patent Application Publication
(10) Pub. No.: US 2023/0342658 A1
(43) Pub. Date: Oct. 26, 2023

(54) PRE-DEPLOYMENT VALIDATION OF INFRASTRUCTURE TOPOLOGY

(71) Applicant: Kyndryl, Inc., New York, NY (US)

(72) Inventors: Sushant Tripathi, Pune (IN); Bala Srinivas Vanapalli, Hyderabad (IN); Shankaramurthy K V, Bangalore (IN); Siddesh Laxmikant Gad, Ponda (IN); Amol Bhaskar Mahamuni, Bangalore (IN)

(21) Appl. No.: 17/726,887

(22) Filed: Apr. 22, 2022

(51) Int. Cl. H04L 41/12; G06N 20/00; H04L 41/16

(52) U.S. Cl. CPC G06N 20/00; H04L 41/12; H04L 41/16

(57) ABSTRACT

Systems and methods enable optimized infrastructure deployment planning and validation. In embodiments, a method includes: training, by a computing device, a machine learning (ML) predictive model with historic infrastructure deployment data of a plurality of resource providers in a network environment, including resource dependencies; generating, by the computing device, a deployment topology for requested resources of an information technology (IT) deployment request of a user; generating, by the computing device using the ML predictive model, a confidence score regarding a likelihood of successful implementation of the deployment request based on dependencies of the deployment topology; and dynamically implementing, by the computing device, deployment of the IT deployment request to provision the requested resources from multiple providers in the network environment based on the confidence score.

### BACKGROUND

Aspects of the present invention relate generally to distributed computing and, more particularly, to pre-deployment validation of infrastructure topology.

The development of cloud computing technology has been an important advancement in provisioning both hardware and software infrastructure. Increasingly, entities are relying on infrastructure comprised of resources and/or services from multiple distinct providers in a distributed cloud environment. Resource deployments for a single business application stack may require the deployment of multiple virtual machines, computer clusters, networks, network security systems, databases, queues, notifications, and alert management resources for each instance of the application, for example.

One cloud computing tool developed for cloud environments is the open source infrastructure as code software tool Terraform®, which is a registered trademark of HashiCorp, Inc. In general, Terraform® provides a command line interface (CLI) workflow to manage cloud services. Terraform® codifies cloud APIs into declarative configuration files, allowing for descriptions of resources using blocks, arguments, and expressions.

### SUMMARY

In a first aspect of the invention, there is a computer-implemented method including: training, by a computing device, a machine learning (ML) predictive model with historic infrastructure deployment data of a plurality of resource providers in a network environment, including resource dependencies; generating, by the computing device, a deployment topology for requested resources of an information technology (IT) deployment request of a user; generating, by the computing device using the ML predictive model, a confidence score regarding a likelihood of successful implementation of the deployment request based on dependencies of the deployment topology; and dynamically implementing, by the computing device, deployment of the IT deployment request to provision the requested resources from multiple providers in the network environment based on the confidence score.

In another aspect of the invention, there is a computer program product including one or more computer readable storage media having program instructions collectively stored on the one or more computer readable storage media. The program instructions are executable to: train a machine learning (ML) predictive model with historic infrastructure deployment data of a plurality of resource providers in a network environment, including resource dependencies; receive an information technology (IT) deployment request for the deployment of at least one resource in the network environment; generate a deployment topology for the deployment request, including resource dependencies; generate, using the ML predictive model, a confidence score regarding a likelihood of successful implementation of the deployment request based on the resource dependencies of the deployment topology; determine whether the deployment request is valid or invalid by comparing the confidence score to a predetermined threshold value; and generate and issue a notification to an end user device in the network environment indicating whether the deployment request is valid or invalid based on the determining whether the deployment request is valid or invalid.

In another aspect of the invention, there is system including a processor, a computer readable memory, one or more computer readable storage media, and program instructions collectively stored on the one or more computer readable storage media. The program instructions are executable to: a processor, a computer readable memory, one or more computer readable storage media, and program instructions collectively stored on the one or more computer readable storage media, the program instructions executable to: train a machine learning (ML) predictive model with historic infrastructure deployment data of a plurality of resource providers in a network environment, including resource dependencies; receive an information technology (IT) deployment request for the deployment of at least one resource in the network environment; generate a deployment topology for the deployment request, including resource dependencies, wherein the deployment topology indicates how constituent parts of the at least one resource and other resources interacting with the at least one resource are interrelated and arranged in the network environment; generate, using the ML predictive model, a confidence score regarding a likelihood of successful implementation of the deployment request based on the resource dependencies of the deployment topology; determine whether the deployment request is valid or invalid by comparing the confidence score to a predetermined threshold value; and generate and issue a notification to an end user device in the network environment indicating whether the deployment request is valid or invalid based on the determining whether the deployment request is valid or invalid.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the invention.

FIG. 5 is a flow diagram in accordance with aspects of the present invention.

FIG. 6 shows a flowchart of exemplary method steps in accordance with aspects of the present invention.

FIG. 7 shows a flowchart of exemplary method steps in accordance with aspects of the present invention.

### DETAILED DESCRIPTION

Aspects of the present invention relate generally to distributed computing and, more particularly, to pre-deployment validation of infrastructure topology. Embodiments of the invention provide for artificial intelligence (AI) based validation of dynamic infrastructure dependencies, and cross-correlation of state data, metadata, and configuration data of various resources, across cloud providers. Implementations of the invention generate confidence scores indicating a likelihood of success of an infrastructure or resource deployment using active learning feedback from end users, historic valid deployment configurations, and historic deployment failures. Embodiments of the invention utilize the confidence scores to validate a desired infrastructure topology. The term topology or infrastructure topology as used herein refers to the way in which constituent parts (resources) of a network environment are interrelated or arranged. In embodiments, the term topology refers to the physical layout of resources in the network environment and/or the logical layout (e.g., the way data passes through the network from one device to the next) of resources within the network environment, including dependencies between resources.

Cloud provider resource deployments are often used by enterprise customers for running their complex application deployments in a cloud environment. A system or human may request provisioning of resources from a target cloud/infrastructure provider for deployment of complex application and services stacks, or may request a provisioning of resources that requires a multistep deployment operation to take place to provision, reserve or destroy collections of cloud resources. In such cases, configurations of some or all of the services/resources to be deployed depend on the state, metadata and configuration of existing services/resources that are already deployed on the target cloud/infrastructure. Such deployment operations may take a large amount of time, in some cases hours, where each resource is deployed one by one or simultaneously. During the course of the deployment, multiple resources may be provisioned (which constitutes an overall deployment), and costs are incurred on a cloud provider’s infrastructure, which are yet to be put to actual use, since the entire deployment has not yet completed and resources and services that are required to complete the deployment are not yet deployed.

In one example, a request may include the use of specific operating system (OS) image identifications (IDs), specific Internet Protocol (IP) addresses, subnetworks or virtual local area network (LAN) classless inter-domain routings (CIDRs) and identifiers, specific block or object storage instances, or other resources to be used for the deployment of new servers, computer clusters or virtual machines, where the new resources to be deployed require the identifiers of other existing resources in order to be configured successfully. Additionally, access and security permissions may be required to be met where a resource to be accessed for the deployment operation is owned by an entity separate from the entity requesting the deployment.

Failure to accurately validate many cross-dependent configuration elements leads to lost time and financial losses if any unmet dependencies cause the deployment to fail after partial completion, requiring the operations to be rolled back. Even when a provider allows rollback for failed deployments, such resources may already be subject to flat or hourly pricing that is incurred during the deployment itself, and in some cases, some resources may not support a complete rollback, requiring specific actions to destroy or decommission them. Therefore, by the time that an issue is faced in the deployment process at some stage, large losses may be accumulated (e.g., loss of time, human effort, and financial resources), which translates to a net loss in business value. Moreover, a deployment failure(s) may lead to disruptions in continuity of operations of an entity or system in which dependencies are affected by the failure(s).

Presently, a system capable of performing complete and comprehensive resource state, metadata, and configuration validation across multiple providers and/or closed or proprietary ecosystems is not available.

Advantageously, implementations of the invention provide comprehensive validation that is applied to such resource deployment, to ensure that an assurance of successfulness of the deployment and its cost is available before any time, effort or finances are expended on a deployment that is likely to fail. In embodiments, a system is provided to authoritatively verify the existence of all resources that exist at a provider, determine a state of the resources, obtain metadata and configuration information regarding the provider and the resources, and utilize this information to determine recourse dependency configurations for the deployment of new services/resources.

Embodiments of the invention provide the ability to conduct a comprehensive zero cost dry run of an infrastructure deployment to ensure that all dependencies are being met, resulting in deployment validation and assurance prior to performing the deployment, thereby removing the risk of failure for a complex deployment. Implementations of the invention constitute an improvement in the technical field of distributed computing by predicting and preventing resource deployment failures, thereby preventing disruptions in continuity of computing system operations resulting from such deployment failures. Moreover, such system improvements save time, human effort, and financial resources expended on failed service/resource deployments, helping achieve quality service level agreements (SLAs) and avoiding wastage of financial allocations.

Advantageously, improved resource deployment systems according to embodiments of the invention are not limited to any specific provider or set of resources, and take into account all resources across multiple providers, as well as business and application specific delineation, classification and organization or hierarchy.

It should be understood that, to the extent implementations of the invention collect, store, or employ personal information provided by, or obtained from, individuals (for example, user passwords and login data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

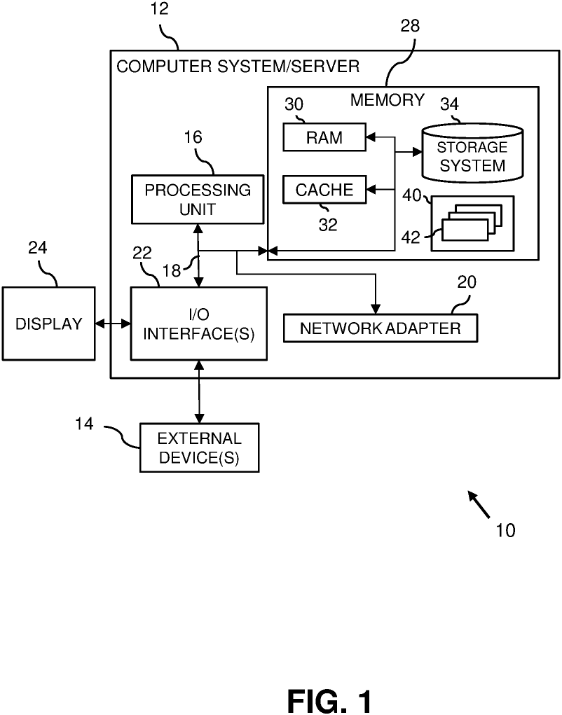

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

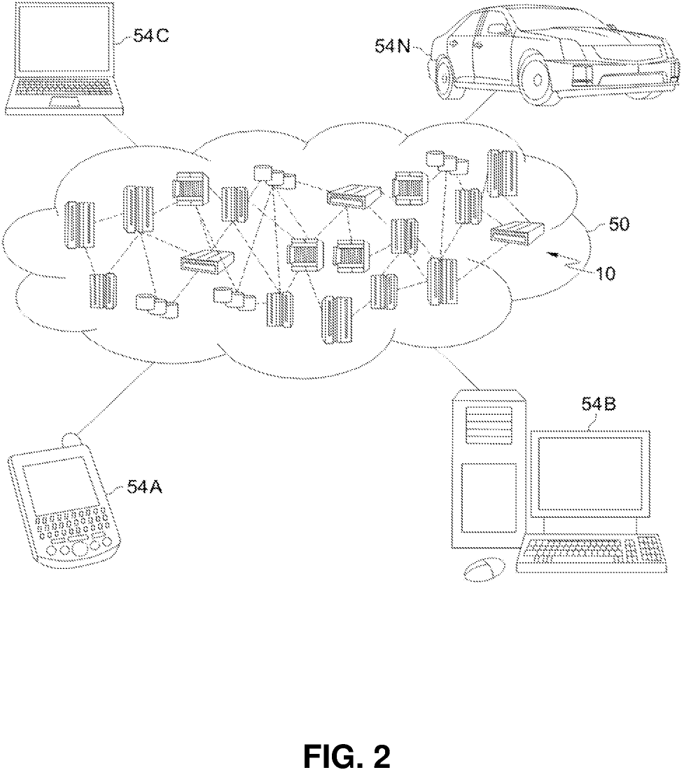

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

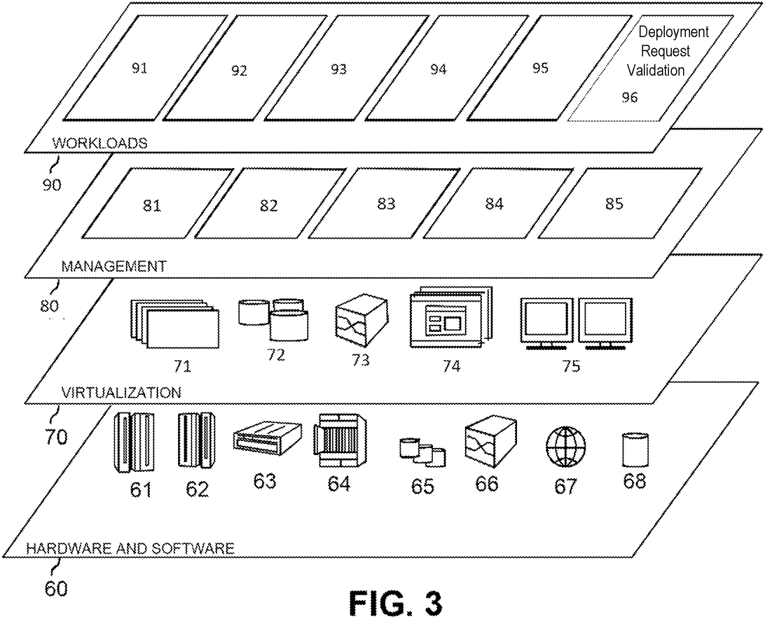

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and deployment request validation 96.

Implementations of the invention may include a computer system/server 12 of FIG. 1 in which one or more of the program modules 42 are configured to perform (or cause the computer system/server 12 to perform) one of more functions of the deployment request validation 96 of FIG. 3. For example, the one or more of the program modules 42 may be configured to: train a machine learning (ML) predictive model with historic infrastructure deployment data of a plurality of resource providers in a network environment, including resource dependencies; receive an information technology (IT) deployment request for the deployment of at least one resource in the network environment; generate a deployment topology for the deployment request, including resource dependencies, wherein the deployment topology indicates how constituent parts of the at least one resource and other resources interacting with the at least one resource are interrelated and arranged in the network environment; generate, using the ML predictive model, a confidence score regarding a likelihood of successful implementation of the deployment request based on the resource dependencies of the deployment topology; determine whether the deployment request is valid or invalid by comparing the confidence score to a predetermined threshold value; generate and issue a notification to an end user device in the network environment indicating whether the deployment request is valid or invalid based on the determining whether the deployment request is valid or invalid; and selectively initiate deployment of a deployment request when the deployment request is valid.

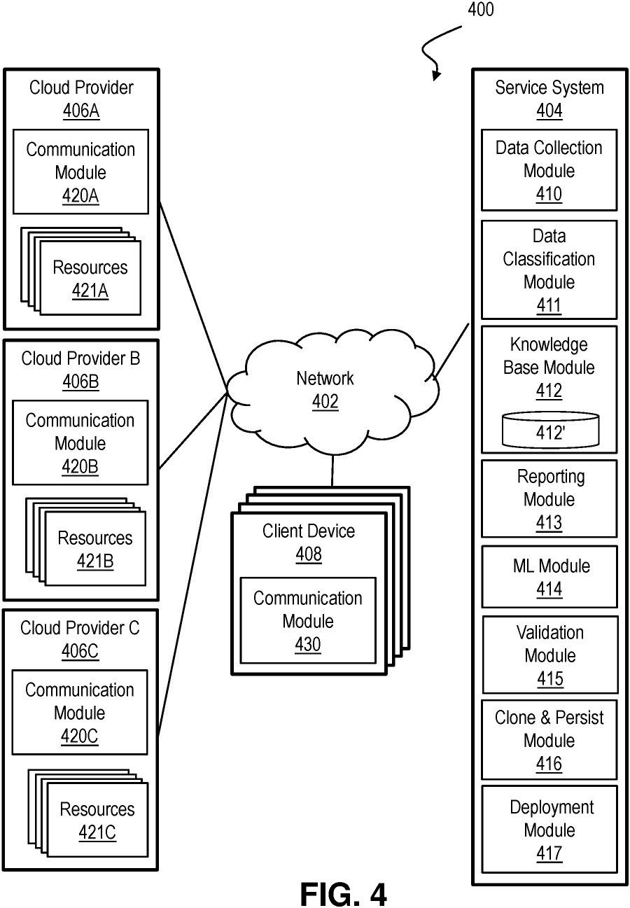

FIG. 4 shows a block diagram of an exemplary environment 400 (e.g., a distributed computing environment) in accordance with aspects of the invention. In embodiments, the environment 400 includes a network 402 enabling communication between one or more of: a service system 404, a plurality of cloud providers represented at 406A-405C, and a plurality of client devices 408.

The service system 404, each of the cloud providers 406A-406C, and each of the client devices 408 may comprise the computer system/server 12 of FIG. 1, or elements thereof. Additionally, the service system 404, each of the cloud providers 406A-406C, and each of the client devices 408 may be computing nodes 10 in the cloud computing environment 50 of FIG. 2. The client devices 408 may be local computing devices used by cloud consumers in the cloud computing environment 50 of FIG. 2 (e.g., PDA or cellular telephone 54A, desktop computer 54B, laptop computer 54C, and/or automobile computer system 54N). In embodiments, the service system 404 is comprised of one or more computer systems (e.g., computer system/server 12 of FIG. 1), and is configured to provide validation services for an infrastructure request prior to deployment of the request.

In embodiments, the service system 404 comprises one or more modules, each of which may comprise one or more program modules such as program modules 42 described with respect to FIG. 1. In the example of FIG. 4, the service system 404 includes one or more of: a data collection module 410, a data classification module 411, a knowledge base module 412, a reporting module 413, a machine learning (ML) module 414, a validation module 415, a clone and persist module 416 and a deployment module 417, each of which may comprise one or more program module(s) 42 of FIG. 1, for example.

In implementations, the data collection module 410 is configured to receive provider data and resources data from one or more providers (e.g., cloud providers 406A-406C) in the environment 400, and obtain and process user infrastructure requests or IT deployment service requests (e.g., received from a client device 408) via the network 402.

In embodiments, the data classification module 411 is configured to: process provider data, resource data and change event data received from one or more cloud providers 406A-406C; determine infrastructure dependencies; generate individual provider infrastructure topologies, deployment request topologies, and overall master topologies for participating cloud providers 406A-406C; classify data based on stored classification rules; and save topology and classification data in a knowledge base 412′ of the knowledge base module 412.

In aspects of the invention, the reporting module 413 is configured to generate notifications and reports, for consumption by users of the distributed computing environment 400.

In implementations, the ML module 414 is configured to train a predictive ML model with historic resource deployment data, including deployment failure events, provider data and resource data. In aspects, the ML module 414 is further configured to update the predictive ML model based on user feedback regarding successful or failed resource deployment events. In embodiments, the trained and updated ML model is utilized to output a confidence score reflecting a likelihood (e.g., probability) of successful implementation of an information technology (IT) deployment request (hereafter deployment request) for new cloud service resources, prior to deployment of the requested resources.

In embodiments, the validation module 415 utilizes output from the ML model and data from the knowledge base 412′ to validate or invalidate a deployment request, wherein validation indicates a likelihood that the deployment request can be successfully implemented, and invalidation indicates a likelihood that the deployment request, or a portion thereof, will fail.

In implementations, the clone and persist module 416 is configured to determine one or more resources of cloud providers 406A-406C that may be reserved or cloned, and reserves and/or clones the resources (e.g., 421A-421C) as necessary to implement deployment of a deployment request.

In aspects of the invention, the deployment module 417 is configured to initiate deployment of resources by one or more cloud providers (e.g., 406A-406C) of the distributed computing environment 400 in response to a deployment request received from a user.

In embodiments, each of the cloud providers 406A-406C comprises one or more modules, each of which may comprise one or more program modules such as program modules 42 described with respect to FIG. 1. Each of the cloud providers 406A-406C may provide respective resources 421A-421C, or services based on the resources 421A-421C. Examples of resources include servers, virtual machines, computer clusters, networks, network security systems, databases, queues, and notification and alert management systems. In the example of FIG. 4, each of the cloud providers 406A-406C includes a respective communications module 420A (e.g., including one or more program module(s) 42 of FIG. 1) configured to send provider data and resource data to the service system 404.

In embodiments, the client devices 408 each include a communication module 430 (e.g., including one or more program module(s) 42 of FIG. 1) configured to communicate and share data with the service system 404.

The service system 404, the cloud providers 406A-406C, and the client devices 408, may each include additional or fewer modules than those shown in FIG. 4. In embodiments, separate modules may be integrated into a single module. Additionally, or alternatively, a single module may be implemented as multiple modules. Moreover, the quantity of devices and/or networks in the environment 400 is not limited to what is shown in FIG. 4. In practice, the environment 400 may include additional devices and/or networks; fewer devices and/or networks; different devices and/or networks; or differently arranged devices and/or networks than illustrated in FIG. 4. For example, while three cloud providers 406A-406C are shown, it should be understood that additional cloud providers may participate in the environment 400.

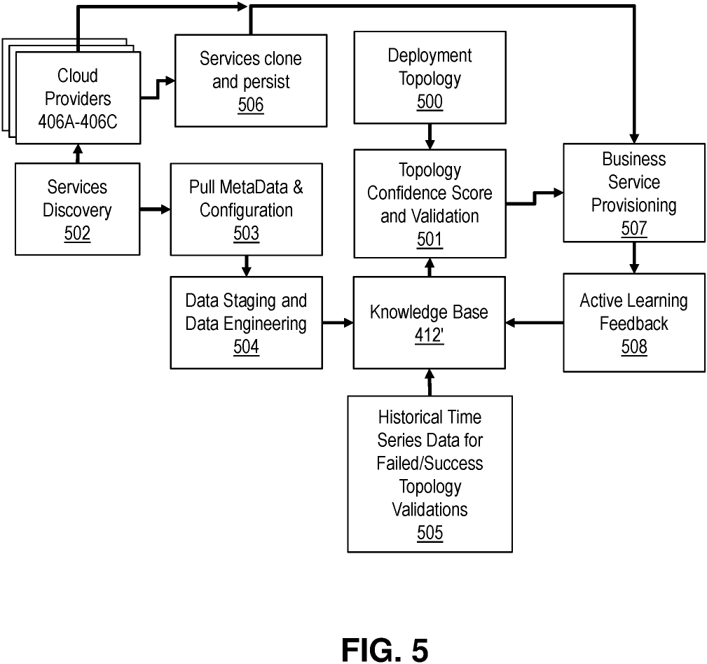

FIG. 5 is a flow diagram in accordance with aspects of the present invention. Steps illustrated in FIG. 5 may be carried out in the environment of FIG. 4 and are described with reference to elements depicted in FIG. 4.

In embodiments, the service system 404 generates a deployment topology 500 based on a deployment request received from an end user (e.g., from a client device 408). The term deployment topology as used herein refers to the way in which constituent parts of resources associated with the deployment request (resources requested and resources interacting with those requested resources) are interrelated or arranged in a network environment (e.g., environment 400 of FIG. 4). In embodiments, the deployment topology comprises a representation of the physical layout of devices utilized by the end user in the network environment 400 and/or the logical layout (e.g., the way data utilized by the end user passes through the network environment from one device to the next), including dependencies. The term dependencies as used herein refers to resources (computer hardware or software) that rely on another resource (computer hardware or software) to implement a function.

Based on the deployment topology 500, at 501 the service system 404 generates a topology confidence score indicating a likelihood that the deployment request can be successfully implemented, and validates the deployment request based on the confidence score and data obtained from the knowledge base 412′. As indicated at 502, the service system 404 performs services discovery to obtain resource metadata and configuration data at 503. At 504, data staging and data engineering is performed to process and classify data obtained from the cloud providers 406A-406C before stored the data in the knowledge base 412′. At 505, the service system 404 saves historic time series data for failed and successful topology validations (e.g., successful, or unsuccessful resource deployment events) in the knowledge base 412′. Prior to deployment, the service system 404 may clone and/or reserve (persist) resources of the cloud providers 406A-406C at 506 as necessary to implement a deployment request. At 507, the service system 404 initiates resource deployment (e.g., business services provisioning) in response to the deployment request. At 508 the end user who provided the deployment request provides active learning feedback regarding the success or failure of the resource deployment or aspects thereof to the knowledge base 412′. The active learning feedback may be utilized to update a trained ML model, which is used at step 501 in the generation of the confidence score.

In an exemplary use scenario, an IT operations manager wants to submit a deployment request including a complex topology of services across multiple cloud providers, which requires resource provisioning to be done in sequence considering interdependencies between the resources. In this example, the IT operations manager wants to provision a virtual machine followed by cloud-based object storage, and then connect the virtual machine and cloud-based object storage to an in-house data center and invoke certain lambda functions (anonymous functions) for in-flight computations. In this example, the IT operation manager intends to use a control tower of a web platform to create and manage IDs and policy governance. In this case, validation services of the service system 404 may be utilized to ensure that all required services are available, are cloned, and can be provisioned, before commencing any resource deployment.

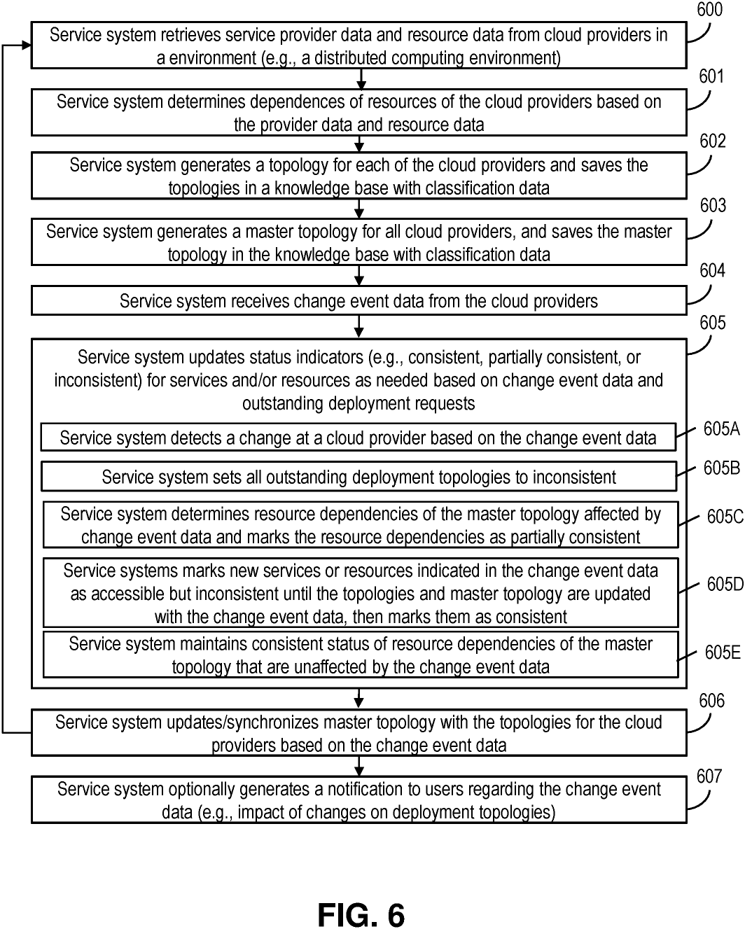

FIG. 6 shows a flowchart of exemplary method steps in accordance with aspects of the present invention. Steps of the method may be carried out in the environment of FIG. 4 and are described with reference to elements depicted in FIG. 4.

At step 600, the service system 404 retrieves (continuously or periodically) service provider data and resource data from participating cloud providers 406A-406C. In embodiments, the service system 404 utilizes application program interfaces (APIs), Software Development Toolkit (SDK), or other interfaces and information retrieval methods available for each of the cloud providers 406A-406C to obtain resource data. Resource data may include, for example, existing resources of each of the cloud providers 406A-406C, resource identifiers, state of resources, and configuration of resources. In aspects of the invention, the service system 404 also utilizes APIs, or other interfaces and information retrieval methods available for each of the cloud providers 406A-406C to obtain provider data. Provider data may include, for example, the existence of regions (e.g., regional servers or data storage), availability zones, network subnets, availability of specific resources across all regions, physical or logical organized points of deployment, and service locations available for the provider. In embodiments, at least a portion of the provider data and/or resource data is in the form of metadata.

When services are provisioned at a cloud provider (e.g., 406A), the cloud provider maintains information on the provider systems and infrastructure, including the service resource name(s), aliases, tags, labels, correlation identifiers, placement with the provider’s constructs such as geo-location information (e.g., region, availability zone) and associations such as network information (e.g., associated IP addresses, virtual private cloud (VPC), network segment, network gateway, uplinks and downlinks), storage information, and other ancillary service associations and operational states (e.g., Available/Stopped/Terminated/Synced/Syncing/ Accessible//In-accessible/ Up/Down). The available state and metadata information is usually different for each service from a cloud provider and is also different for different cloud providers. Additionally, state and metadata information depends on a cloud provider’s architecture and design for their system(s), infrastructure and services provided, and how a provider wishes to define, categorize, externalize, and expose this information. In implementations, the data obtained at step 600 may include any information maintained by a cloud provider (e.g., 406A) on their systems and infrastructure, including metadata and other stored information. In implementations, the service system 404 continuously monitors data from participating cloud providers 406A-406C. In embodiments, the data collection module 410 of the service system 404 implements step 600.

At step 601, the service system 404 determines dependencies of resources in the environment 400 based on the service provider data and resource data obtained at step 600. In aspects, the service system 404 determines dependencies based on stored rules and the data received at step 600. In embodiments, the data classification module 411 of the service system 404 implements step 601.

At step 602, the service system 404 generates a topology for each of the cloud providers 406A-406C based on the received provider data, resource data, and determined dependencies, and saves the topologies in the knowledge base 412′ with classification data. In embodiments, the service system 404 classifies infrastructure information of each cloud provider 406A-406C to generate a hierarchical topology enumerating and classifying all physical and logical entities of respective cloud providers 406A-406C. In implementations, the topology or hierarchical topology comprises a representation of the physical layout of devices of a cloud provider in the network environment (e.g., environment 400 of FIG. 4) and/or the logical layout (e.g., the way data of the cloud provider 406A-406C passes through the network environment from one device to the next), including resource dependencies. In embodiments, the data classification module 411 of the service system 404 implements step 602.

At step 603, the service system 404 generates a master topology for all cloud providers (e.g., 406A-406C), and saves the master topology in the knowledge base 412′ with classification data. In implementations, the master topology comprises a representation of the physical layout of devices of all participating cloud providers 406A-406C in the network environment (e.g., environment 400 of FIG. 4) and/or the logical layout (e.g., the way data of the cloud providers 406A-406C passes through the network environment from one device to the next), including resource dependencies.

In embodiments, the master topology is a hierarchical topology enumerating and classifying the physical and logical entities of all participating cloud providers 406A-406C. In aspects of the invention, the service system 404 stores status indicators for resources of the master topology, wherein the status indicators indicate an operational and/or availability state of respective resources with respect to the master topology. The master topology is kept updated with the changes and dependencies in resource status, and also includes status indicators. Examples of status indicators include: consistent, inconsistent, and partially consistent. In implementations, the knowledge base 412′ includes resource dependencies and multi-variate correlation of state, metadata, and configuration data of various resources across participating cloud providers 406A-406C to arrive at application specific delineation, and business service classification, where organization or hierarchy is represented by the hierarchical master topography based on how end users are utilizing the resources of the network environment. In embodiments, the data classification module 411 of the service system 404 implements step 603.

At step 604, the service system 404 receives (continuously or periodically) change event data from the cloud providers 406A-406C, where the change event data indicates a change to resource data and/or provider data. In embodiments, the service system 404 utilizes event-based or poll-based data retrieval methods to receive notifications from the cloud providers 406A-406C regarding changes to the resource data and/or provider data that affects the topology of the cloud providers 406A-406C. Receiving change event data may occur dynamically as a continuous near real-time process. In embodiments, the data collection module 410 of the service system 404 implements step 604.

Initiation of a deployment request causes the creation of new resources, or causes changes to existing resources of one or more cloud providers 406A-406D. In embodiments, the service system 404 creates a separate deployment topology for each deployment request. Additionally, changes may occur at a cloud provider (e.g., 406A) due to external actors, systems, and other factors. Changes at a cloud provider may result in a loss of resource synchronization at the service system 404 as of a last time resource information was retrieved and utilized by the service system 404 (e.g., for generating degree of confidence metrics for feasibility of deployment, cost, time to deploy and dependency locking in order to process an ongoing deployment request). In embodiments, to avoid problems related to such inconsistencies, the service system 404 continually receives change information from the cloud providers 406A-406C and monitors changes at the provider.

At step 605, the service system 404 updates status indicators for services and/or resources of the cloud providers (e.g., 406A-406C) in the knowledge base 412′ as needed based on the change event data received at step 604, and outstanding deployment requests. Change event data may indicate, for example, newly available resources, removal of resources, and changes in the state of resources (e.g., availability of resources). In aspects of the invention, the service system 404 identifies whether any requested deployment requests involve any resource dependencies that are affected by the change. In embodiments, the data classification module 411 of the service system 404 implements step 605. Implementations of step 605 may include the following substeps 605A-605E.

At substep 605A, the service system 404 detects a change at a cloud provider (e.g., 406A) based on the change event data received at step 604 and stored rules (e.g., correlating certain change event data with changes). In implementations, the change detected is a change to one or more resources available in the environment 400, and/or a change in a state of one or more resources in the environment 400.

At substep 605B, the service system 404 sets a state for deployment topologies of outstanding deployments (deployments not yet initiated) to inconsistent in response to determining that a change has occurred at substep 605A.

At substep 605C, the service system 404 determines, for the requested resources of outstanding deployment requests, corresponding resource dependencies of the master topology affected by the detected change, and marks the resource dependencies as partially consistent.

At substep 605D, the service system 404 marks new services or resources indicated in the change event data as accessible (i.e., they can be partially seen) but inconsistent (i.e., they cannot be used as dependencies in ongoing deployments) until the provider topologies and master topology in the knowledge base 412′ are fully updated with resource data and/or provider data associated with the new services or resources, at which point the service system 404 marks the new services or resources as consistent.

At substep 605E, the service system 404 maintains, for the requested resources of outstanding deployment requests, a consistent status for resource dependencies of the master topology that are unaffected by the change event data.

At step 606, the service system 404 updates or synchronizes the master topology with the topologies for the cloud providers (406A-406C) based on the change event data. In aspects of the invention the service system 404 performs parallel synchronization and updating of the master topology in response to one or more detected changes at substep 605A, whereby the service system 404 re-retrieves resource data, metadata, and resource state information from one or more of the cloud providers 406A-406C based on the change event data. In aspects, the service system 404 creates a demand for change update, causing the service system 404 to retrieve on demand change information from one or more of the cloud providers (406A-406C) in order to update the master topology in the knowledge base 412′. In embodiments, the data classification module 411 of the service system 404 implements step 606.

At step 607, the service system 404 optionally generates a notification to one or more end users regarding the change event data (e.g., impact of changes on deployed topologies). In implementations, the service system 404 sends notifications to subscribed end users about the impact of detected changes at the time they are detected by the service system 404 (in real-time or near real-time). In embodiments, the reporting module 413 of the service system 404 implements step 607.

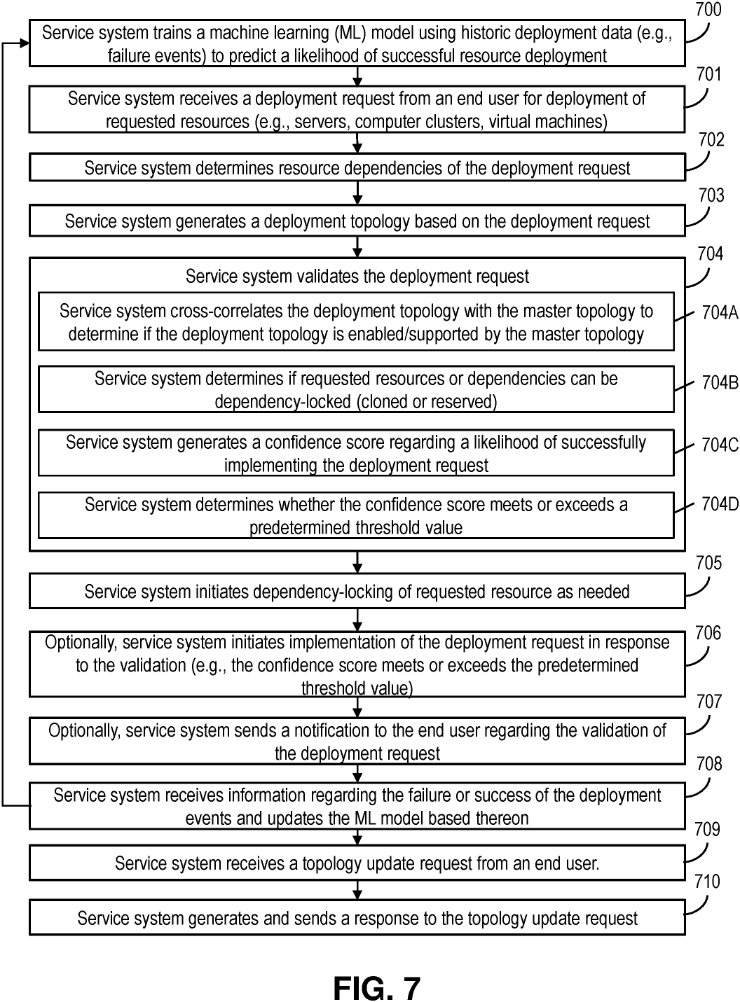

Based on the above, it can be understood that end users who submit deployment requests to the service system 404 may not be affected by the detected change of step 605A, in which case the service system 404 may process their deployment request as discussed at FIG. 7. In implementations, the service system 404 is always ready to process more deployment requests, and receives and updates information in the knowledge base 412′ dynamically. In this way, the service system 404 reduces the impact of change events and the impact of time latency to update the knowledge base 412′ based on the change events, and enables multiple activities to be executed in parallel, without significantly affecting the performance or availability of the system or the system’s capability to process further user input or other activity.

FIG. 7 shows a flowchart of exemplary method steps in accordance with aspects of the present invention. Steps of the method may be carried out in the environment of FIG. 4 and are described with reference to elements depicted in FIG. 4.

At step 700, the service system 404 trains a ML model or artificial intelligence (AI) model using historic deployment data (e.g., time series data for sufficient duration, of successful and failed deployment topologies) including historic configurations and resource dependencies, to predict a likelihood (e.g., probability) of successful deployment. In embodiments, the ML module 415 of the service system 404 implements step 700.

At step 701, the service system 404 receives a deployment request (e.g., an IT deployment request) from an end user for deployment of requested resources (e.g., servers, computer clusters, virtual machines, etc.) or associated services. In embodiments, the deployment request is in the form of software code, such as from an infrastructure as code software tool (e.g., Terraform® by HashiCorp, Inc.). In implementations, new resources to be deployed require identifiers of existing resources (e.g., in the environment 400) in order to be configured successfully. In embodiments, new resources to be deployed require access and security permissions to be met (e.g., a resource to be accessed for the deployment is owned by an entity separate from the end user requesting the deployment and requires an access code or ID). In embodiments, the validation module 415 of the service system 404 implements step 701.

At step 702, the service system 404 determines resource dependencies associated with the deployment request. In embodiments, the service system 404 determines the resource dependencies based on the deployment request and information in the knowledge base 412′, including dependencies of the master topology. For example, a deployment request for resources may require a resource, such as a virtual machine, which needs a virtual private cloud (VPC) identifier as a pre-requisite to create the virtual machine. In embodiments, the data classification module 411 of the service system 404 implements step 702.

At step 703, the service system 404 generates a deployment topology for the end user based on the deployment request, including the resource dependencies. As previously noted, the term deployment topology as used herein refers to the way in which constituent parts of resources associated with the deployment request (resources requested and resources interacting with those requested resources) are interrelated or arranged in a network environment (e.g., environment 400 of FIG. 4). In implementations, the service system 404 classifies information of the deployment topology on the basis of whether it is feasible to clone or reserve requested resources, in order to ensure their continued existence at the cloud provider to avoid a deployment failure (e.g., if the resource is move, deleted, or removed during the course of the deployment). Classification information may be stored with the deployment topology in the knowledge base 412′. In general, the ability to reserve or clone a resource results in a higher confidence score (indicating the feasibility of the requested deployment). In embodiments, the data classification module 411 of the service system 404 implements step 703.

At step 704, the service system 404 validates the deployment request based on the knowledge base 412′. In implementations, the service system 404 validates the deployment request to determine whether deployment of resources should be initiated by the services system 404 or declined. In aspects of the invention, the validation includes the service system 404 determining dynamic dependencies across the deployment topology and verification of the existence of dependent resources and their availability state, configuration, and metadata without processing any deployment request (e.g., without initiating provisioning of resources) or incurring any cost to the end user. In embodiments, the validation module 415 of the service system 404 implements step 704. In implementations, the services system 404 validates the deployment request using substeps 704A-704D set forth below.

At step 704A, the service system 404 cross-correlates the deployment topology with the master topology to determine if the deployment topology is enabled or supported by the master topology. In implementations, the service system 404 cross-correlates by comparing resource requirements of the deployment topology with existing resources and dependencies in the master topology, and the state of resources (e.g., consistent, inconsistent), to determine if the deployment topology is supported by, or possible in view of, the master topology. In this way, the service system 404 can also determine if the deployment request will require or remove any resource present in the master topology in a way that will break or interfere with other dependencies in the master topology.

At step 704B, the service system 404 determines if requested resources or their dependencies can be dependency-locked (cloned and/or reserved). In implementations, the service system 404 determines, based on the classification data associated with the deployment topology, whether the requested resources or other resources on which the requested resources depend can be cloned or reserved for a time period extending to the end of the deployment requested at step 701.

At step 704C, the service system 404 generates a confidence score regarding a likelihood of successfully implementing the deployment request based on steps 704A and 704B, and the ML model. In implementations, the service system 404 utilizes active learning feedback from the end user, historic valid deployment configurations, and historic deployment configuration failures, to validate or invalidate the deployment request. In embodiments, the confidence score represents a feasibility of successful deployment of requested resources based on cost and time required to deploy the resources, without incurring costs, and while saving cost liability related to failed or partial deployments that result in rollback, causing deployment and invoicing of rolled back resources.

In aspects of the invention, the service system 404 finds dependencies from certain services required by the deployment request that require the service system 404 to validate “availability” of those dependent services, as well as ensure the entire end-to-end service chaining will succeed. Given the dynamic nature of these dependencies, implementations of the invention utilize artificial intelligence (AI) to study the dependent resources, their state, their configuration (and various configuration options) and metadata, in order to accurately predict the dependency of certain services in real-time. In embodiments, the service system 404 is configured to predict that service-chaining will succeed and is deployable end-to-end, without actually implementing any deployment, and therefore without incurring any costs of deployment up front. From this perspective, as the service system 404 gathers a list of requested resources and/or services and also determines dependencies thereof in real-time, the AI or ML model of the invention can start predicting what is the confidence with which the service system 404 can claim that the desired service chaining will be successful and hence deployable. In implementations, the confidence score may be anywhere between 0-100 percent, and the ML model is trained with historic time series data of historically successful configurations to be able to make this prediction. The ML models of the invention, in this context, can be complex neural networks such as long short term memory (LSTM) or hierarchical temporal memory (HTM) networks. LSTM and HTM are different recurrent neural network (RNN) models which have memory elements and are feed-forward type models with multiple middle neural layers to enable learning complex situations with historical data.

At step 704D, the service system 404 determines whether the confidence score meets or exceeds a predetermined stored threshold value. In implementations, if a confidence score meets or exceeds the predetermine threshold value, the service system 404 determines that the deployment request should proceed (is valid), whereas if the confidence score is below the predetermined threshold value, the service system 404 determines that the deployment request should not proceed (is invalid).

At step 705, the service system 404 initiates dependency-locking (cloning or reserving) of resources requested by the deployment request, or dependencies required for the deployment request, as needed. In implementations, in order to ensure that the requested resources are not lost or removed during the course of the deployment, the service system 404 reserves or clones any resources for which the cloud provider at issue supports the reservation or cloning (e.g., creates perfect copies of resources, or reserves resources when providers enable the resources to be reserved/dynamically persisted until projected overall deployment latency) to ensure the actual provisioning of resources does not fail. In implementations, persistent clones go through provisioning compliance at the time of deployment to ensure the persistent clones cater to any vulnerability compliance and security considerations. In aspects of the invention, the reservation of resources occurs during or concurrently with validation of the deployment request. In embodiments, the clone and persist module 416 of the service system 404 implements step 705.

At step 706, the service system 404 optionally initiates implementation of the deployment request in response to the validation at step 703. In implementations, the service system 404 automatically or dynamically initiates implementation of the deployment request (e.g., initiates provisioning of one or more resources of one or more cloud providers 406A-406C) in response to the confidence score meeting or exceeding the predetermined threshold value at substep 704D. In embodiments, step 706 comprises the service system 404 sending a provisioning request to one or more remote cloud providers (e.g., 406A-406C) via the network 402. In implementations, step 706 comprises the service system 404 configuring one or more resources (e.g., hardware or software) based on the deployment request of the end user, where the configuring may include managing access to data and/or resource through creating, modifying, deleting, or disabling user accounts, for example. In embodiments, the deployment module 417 of the service system 404 implements step 706.

At step 707, the service system 404 optionally sends a notification to the end user (e.g., via a client device 408) regarding the validation of the deployment request at step 704. By way of example, the notification may indicate a confidence score, a notification that the deployment request is valid and can be implemented, or an indication that the deployment request is invalid and should not or cannot be implemented. In embodiments, the notification includes reasoning explaining the outcome of the validation, such as a specific step of the deployment that cannot be completed and the reasons why it cannot be completed. In embodiments, the reporting module 413 of the service system 404 implements step 707.

At 708, the service system 404 receives information regarding the failure or success of the requested deployment, or steps thereof, from one or more end users (e.g., via the client devices 408) and updates the ML model based thereon (active or continuous learning). In this way, the service system 404 can determine whether predictions (e.g., confidence scores) were accurate based on the feedback from end users, and can make adjustments to the ML model accordingly to improve the accuracy of predictions over time. In embodiments, the ML module 414 of the service system 404 implements step 708.

At step 709, the service system 404 receives a topology update request from an end user (e.g., via a client device 408). In implementations, to ensure that an end user maintains parity with cloud providers 406A-406C, an end user or a system of the end user can request a topology update during the course of a life cycle or workflow that is being performed by the end user or the end user’s system. In embodiments, the data collection module 410 of the service system 404 implements step 709.

At step 710, the service system 404 generates and sends a response to the topology update request of step 709 including up-to-date topology information of the end user. In embodiments, the reporting module 413 of the service system 404 implements step 710.

Based on the above it can be understood that embodiments of the invention enable provisioning of complex applications and/or services across multiple cloud providers depending on the state, metadata, and configuration of existing resources and/or services that are already deployed on a target cloud environment/infrastructure where new resources to be deployed require identifiers of other existing resources in order to be configured successfully. Failure to accurately validate many cross-dependent configuration elements leads to lost time and financial losses if any unmet dependencies cause the deployment to fail after partial completion, requiring the operations to be rolled back and incurring loss of time and costs (e.g., costs for resources that do not support a complete rollback). Implementations of the invention support a zero cost a priori validation of deployment requests before any deployment is actually performed, saving substantial time and costs.

In one exemplary scenario, an application stack is deployed on a resource platform with three worker nodes, one network security firewall, one domain name system (DNS) zone with ten record sets, one virtual private cloud (VPC), one private and one public subnet allocation, internal and external IP addresses, database and message queuing services, cloud monitoring services, and notification services. This deployment would take approximately two hours for deployment to complete, wherein the majority of resources are deployed within the first few minutes of the start of the deployment. In the case of failed deployment due to dependency resolution failure for resource availability, resources that are deployed must be removed or rolled back in order to redo the deployment in a consistent manner.

For a software as a service (SaaS) application which undergoes continuous development, the customer’s development, DevOps, and other line of business teams that request deployments of the SaaS application may require performing or testing the deployment multiple times per team per day. In this example, it is estimated there are two deployments per person per day. Given an exemplary cost of two deployments of $70.00 per person per day, and an exemplary cost of resources for the failed deployments of $100.00 per person per day, the total cost would equate to $170 per person per day. A customer having globally distributed teams could easily incur failed deployment costs for forty or more employees every day. Implementations of the invention prevent system down time losses due to failed deployment, as well as preventing users from incurring significant monetary costs for failed deployments.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
training, by a computing device, a machine learning (ML) predictive model with historic infrastructure deployment data of a plurality of resource providers in a network environment, including resource dependencies;
generating, by the computing device, a deployment topology for requested resources of an information technology (IT) deployment request of a user;
generating, by the computing device using the ML predictive model, a confidence score regarding a likelihood of successful implementation of the deployment request based on dependencies of the deployment topology; and
dynamically implementing, by the computing device, deployment of the IT deployment request to provision the requested resources from multiple providers in the network environment based on the confidence score.

2. The method of claim 1, wherein the deployment topology indicates how constituent parts of the requested resources and other resources interacting with the requested resources are interrelated and arranged in the network environment.

3. The method of claim 2, further comprising determining, by the computing device, an availability state of the requested resources and the other resources interacting with the requested resources, wherein the generating the confidence score is further based on the state of the requested resources and the other resources interacting with the requested resources.

4. The method of claim 1, further comprising:
accessing, by the computing device, a master topology indicating how resources of the plurality of resource providers are interrelated and arranged in the network environment; and
determining, by the computing device, that the deployment topology is enabled by the master topology.

5. The method of claim 4, further comprising:
continuously monitoring, by the computing device, change event data from one or more of the plurality of resource providers in real-time; and
updating, by the computing device in real-time, one or more stored availability states of the resources of the plurality of resource providers in the master topology based on the change event data, wherein the determining that the deployment topology is enabled by the master topology is based on the one or more stored availability states.

6. The method of claim 1, further comprising:
determining, by the computing device, one or more of the requested resources or their dependencies can be dependency-locked; and
dependency-locking the one or more of the requested resources for a time period persisting until a completion of the deployment of the IT deployment request.

7. The method of claim 1, further comprising updating, by the computing device, the ML model based on data regarding the deployment of the IT deployment.

8. The method of claim 1, further comprising generating and sending, by the computing device, a notification including the confidence score to an end user device in the network environment.

9. The method of claim 1, wherein the computing device includes software provided as a service in a cloud environment.

10. A computer program product comprising one or more computer readable storage media having program instructions collectively stored on the one or more computer readable storage media, the program instructions executable to:
train a machine learning (ML) predictive model with historic infrastructure deployment data of a plurality of resource providers in a network environment, including resource dependencies;
receive an information technology (IT) deployment request for the deployment of at least one resource in the network environment;
generate a deployment topology for the deployment request, including resource dependencies;
generate, using the ML predictive model, a confidence score regarding a likelihood of successful implementation of the deployment request based on the resource dependencies of the deployment topology;
determine whether the deployment request is valid or invalid by comparing the confidence score to a predetermined threshold value; and
generate and issue a notification to an end user device in the network environment indicating whether the deployment request is valid or invalid based on the determining whether the deployment request is valid or invalid.

11. The computer program product of claim 10, wherein the deployment topology indicates how constituent parts of the at least one resource and other resources interacting with the at least one resource are interrelated and arranged in the network environment.

12. The computer program product of claim 11, wherein the program instructions are further executable to determine an availability state of the at least one resource and the other resources interacting with the at least one resource, wherein the generating the confidence score is further based on the state of the at least one resource and the other resources interacting with the at least one resource.

13. The computer program product of claim 10, wherein the program instructions are further executable to:
access a master topology indicating how resources of the plurality of resource providers are interrelated and arranged in the network environment; and
determine whether the deployment topology is enabled by the master topology.

14. The computer program product of claim 13, wherein the program instructions are further executable to:
continuously monitor change event data from one or more of the plurality of resource providers in real-time; and
update, in real-time, one or more stored availability states of the resources of the plurality of resource providers in the master topology based on the change event data, wherein the determining that the deployment topology is enabled by the master topology is based on the one or more stored availability states.

15. The computer program product of claim 10, wherein the program instructions are further executable to:
determine whether the at least one resource and the resource dependencies or a subset of the at least one resource and the resource dependencies can be dependency-locked; and
dependency-locking the at least one resource and the resource dependencies or a subset of the at least one resource and the resource dependencies for a time period persisting until a completion of a deployment of the IT deployment request.

16. The computer program product of claim 10, wherein the program instructions are further executable to:
initiate deployment of the at least one resource; and
update the ML model based on data regarding the deployment of the at least one resource.

17. A system comprising:
a processor, a computer readable memory, one or more computer readable storage media, and program instructions collectively stored on the one or more computer readable storage media, the program instructions executable to:
train a machine learning (ML) predictive model with historic infrastructure deployment data of a plurality of resource providers in a network environment, including resource dependencies;
receive an information technology (IT) deployment request for the deployment of at least one resource in the network environment;
generate a deployment topology for the deployment request, including resource dependencies, wherein the deployment topology indicates how constituent parts of the at least one resource and other resources interacting with the at least one resource are interrelated and arranged in the network environment;
generate, using the ML predictive model, a confidence score regarding a likelihood of successful implementation of the deployment request based on the resource dependencies of the deployment topology;
determine whether the deployment request is valid or invalid by comparing the confidence score to a predetermined threshold value; and
generate and issue a notification to an end user device in the network environment indicating whether the deployment request is valid or invalid based on the determining whether the deployment request is valid or invalid.

18. The system of claim 17, wherein the program instructions are further executable to:
access a master topology indicating how resources of the plurality of resource providers are interrelated and arranged in the network environment; and
determine whether the deployment topology is enabled by the master topology.

19. The system of claim 18, wherein the program instructions are further executable to:
continuously monitor change event data from one or more of the plurality of resource providers in real-time;
update, in real-time, one or more stored availability states of the resources of the plurality of resource providers in the master topology based on the change event data, wherein the determining that the deployment topology is enabled by the master topology is based on the one or more stored availability states; and
determine an availability state of the at least one resource and the other resources interacting with the at least one resource, wherein the generating the confidence score is further based on the state of the at least one resources and the other resources interacting with the at least one resource.

20. The system of claim 17, wherein the program instructions are further executable to:
determine whether the at least one resource and the resource dependencies or a subset of the at least one resource and the resource dependencies can be dependency-locked; and
dependency-locking the at least one resource and the resource dependencies or a subset of the at least one resource and the resource dependencies for a time period persisting until a completion of a deployment of the IT deployment request.
